(19) United States
(12) Patent Application Publication
(10) Pub. No.: US 2026/0246586 A1
(43) Pub. Date: Aug. 20, 2026

(54) DATA COLLECTION WITH IDEAL AND NON-IDEAL CHANNEL ESTIMATION

(71) Applicant: QUALCOMM Incorporated, San Diego, CA (US)

(72) Inventors: Chenxi HAO, Beijing (CN); Taesang YOO, San Diego, CA (US); Jay Kumar SUNDARARAJAN, San Diego, CA (US); Pavan Kumar VITTHALADEVUNI, San Diego, CA (US); Yu ZHANG, San Diego, CA (US); June NAMGOONG, San Diego, CA (US); Krishna Kiran MUKKAVILLI, San Diego, CA (US); Tingfang JI, San Diego, CA (US); Abdelrahman Mohamed Ahmed Mohamed IBRAHIM, San Diego, CA (US); Naga BHUSHAN, San Diego, CA (US)

(21) Appl. No.: 18/876,604

(22) PCT Filed: Sep. 2, 2022
(86) PCT No.: PCT/CN2022/116686

§ 371 Date: Dec. 18, 2024

(51) Int. Cl. H04L 5/00

(52) U.S. Cl. CPC H04L 5/005

(57) ABSTRACT

Certain aspects of the present disclosure provide wireless communications by a user equipment (UE), generally including receiving signaling indicating a configuration of channel state information (CSI) reference signal (CSI-RS) resources, obtaining, from the configuration, at least first and second CSI-RS patterns, wherein the first CSI-RS pattern indicates a higher density of CSI-RS in a channel frequency range, than the second CSI-RS pattern, collecting target model output data for a machine learning (ML) model, based on channel measurements taken according to the first CSI-RS pattern, collecting nominal data for training the ML model, based on channel measurements taken according to the second CSI-RS pattern, and transmitting at least the target model output data to an entity for training the ML model.

Aspects of the present disclosure relate to wireless communications, and more particularly, to techniques for collecting data for training a machine learning (ML) model.

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications by a user equipment (UE). The method includes receiving signaling indicating a configuration of channel state information (CSI) reference signal (CSI-RS) resources; obtaining, from the configuration, at least first and second CSI-RS patterns, wherein the first CSI-RS pattern indicates a higher density of CSI-RS in a channel frequency range, than the second CSI-RS pattern; collecting target model output data for a machine learning (ML) model, based on channel measurements taken according to the first CSI-RS pattern; collecting nominal data for training the ML model, based on channel measurements taken according to the second CSI-RS pattern; and transmitting at least the target model output data to an entity for training the ML model.

Another aspect provides a method of wireless communications by a UE. The method includes receiving signaling indicating a configuration of a channel state information (CSI) reference signal (CSI-RS) pattern; collecting target model output data for a machine learning (ML) model, based on channel measurements taken according to the CSI-RS pattern; generating nominal data for training the ML model by adding artificial noise to the target model output data; and transmitting at least the target model output data to an entity for training the ML model.

Another aspect provides an apparatus of wireless communication. The apparatus includes a memory and a processor coupled to the memory. The processor is configured to receive signaling indicating a configuration of channel state information (CSI) reference signal (CSI-RS) resources; obtain, from the configuration, at least first and second CSI-RS patterns, wherein the first CSI-RS pattern indicates a higher density of CSI-RS in a channel frequency range, than the second CSI-RS pattern; collecting target model output data for a machine learning (ML) model, based on channel measurements taken according to the first CSI-RS pattern; collect nominal data for training the ML model, based on channel measurements taken according to the second CSI-RS pattern; and transmit at least the target model output data to an entity for training the ML model.

Another aspect provides an apparatus of wireless communication. The apparatus includes a memory and a processor coupled to the memory. The processor is configured to receive signaling indicating a configuration of a channel state information (CSI) reference signal (CSI-RS) pattern; collect target model output data for a machine learning (ML) model, based on channel measurements taken according to the CSI-RS pattern; generate nominal data for training the ML model by adding artificial noise to the target model output data; and transmit at least the target model output data to an entity for training the ML model.

Another aspect provides an apparatus of wireless communication. The apparatus includes means for receiving signaling indicating a configuration of channel state information (CSI) reference signal (CSI-RS) resources; means for obtaining, from the configuration, at least first and second CSI-RS patterns, wherein the first CSI-RS pattern indicates a higher density of CSI-RS in a channel frequency range, than the second CSI-RS pattern; means for collecting target model output data for a machine learning (ML) model, based on channel measurements taken according to the first CSI-RS pattern; means for collecting nominal data for training the ML model, based on channel measurements taken according to the second CSI-RS pattern; and means for transmitting at least the target model output data to an entity for training the ML model.

Another aspect provides an apparatus of wireless communication. The apparatus includes means for receiving signaling indicating a configuration of a channel state information (CSI) reference signal (CSI-RS) pattern; means for collecting target model output data for a machine learning (ML) model, based on channel measurements taken according to the CSI-RS pattern; means for generating nominal data for training the ML model by adding artificial noise to the target model output data; and means for transmitting at least the target model output data to an entity for training the ML model.

Another aspect provides a non-transitory computer-readable medium having instructions stored thereon for receiving signaling indicating a configuration of channel state information (CSI) reference signal (CSI-RS) resources; obtaining, from the configuration, at least first and second CSI-RS patterns, wherein the first CSI-RS pattern indicates a higher density of CSI-RS in a channel frequency range, than the second CSI-RS pattern; collecting target model output data for a machine learning (ML) model, based on channel measurements taken according to the first CSI-RS pattern; collecting nominal data for training the ML model, based on channel measurements taken according to the second CSI-RS pattern; and transmitting at least the target model output data to an entity for training the ML model.

Another aspect provides a non-transitory computer-readable medium having instructions stored thereon for receiving signaling indicating a configuration of a channel state information (CSI) reference signal (CSI-RS) pattern; collecting target model output data for a machine learning (ML) model, based on channel measurements taken according to the CSI-RS pattern; generating nominal data for training the ML model by adding artificial noise to the target model output data; and transmitting at least the target model output data to an entity for training the ML model.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates a general functional framework applied for AI-enabled RAN intelligence.

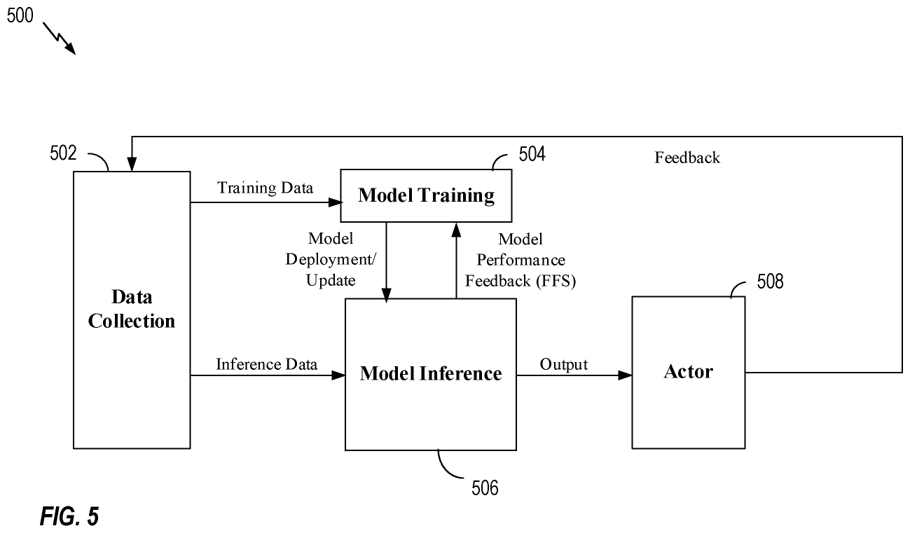

FIG. 6 depicts an example of an ML-based CSI feedback mechanism.

FIG. 7 depicts an example of encoder input and decoder output for the ML-based CSI feedback mechanism of FIG. 6.

FIG. 8 depicts an example training of an ML-based CSI feedback mechanism.

FIG. 9 depicts an example training of an ML-based CSI feedback mechanism, in accordance with aspects of the present disclosure.

FIGS. 10A and 10B depict examples of obtaining downlink precoders based on high and low density reference signal (RS) patterns, in accordance with aspects of the present disclosure.

FIG. 11 depicts an example of a high density RS pattern, in accordance with aspects of the present disclosure.

FIG. 12 depicts an example of a low density RS pattern, in accordance with aspects of the present disclosure.

FIG. 13 depicts how an estimated precoder may be obtained by adding noise to a target precoder, in accordance with aspects of the present disclosure.

FIG. 14 depicts a method for wireless communications.

FIG. 15 depicts a method for wireless communications.

FIG. 16 depicts aspects of an example communications device.

### DETAILED DESCRIPTION

Aspects of the present disclosure relate to wireless communications, and more particularly, to techniques for collecting data for training a machine learning (ML) model.

Understanding the channel state between devices communicating in a wireless communications system is one aspect of improving the performance of wireless communications. Various techniques have been employed for measuring the channel state and reporting feedback so that performance can be improved. For example, performance can be improved by measuring the channel state and reporting feedback. Channel state information (CSI) feedback reporting may be based on a codebook. The codebook may be used as a precoding matrix indicator (PMI) dictionary from which a user equipment (UE) may report the best PMI codewords for a given channel condition, and use a sequence of bits to report the PMI. In other words, rather than feedback actual values, as PMI codewords, a UE may just feedback a set of bits that represents an entry into the codebook, which reduces signaling overhead. Upon receiving the feedback, the network entity may retrieve the PMI codewords from the codebook. Such techniques are often relatively slow, power hungry, and static in approach.

Artificial Intelligence (AI) or Machine learning (ML) represents an opportunity to potentially improve techniques for measuring channel state and reporting feedback. For example, machine learning models may reduce the number of resource elements needed for estimating a channel state (reducing signaling overhead), and improve the estimates of values used in reporting the estimated channel state (e.g., by training ML models to improve accuracy of channel estimation). In some cases, ML-based CSI feedback may replace codebook-based processing by a CSI encoder and decoder (at least the decoder is needed). In such cases, the encoder may be analogous to the PMI searching algorithm, while the decoder may be analogous to the PMI codebook used to translate the CSI reporting bits to a PMI code word.

In some cases, a UE may be configured with a reference signal (RS) configuration to collect data to use for training an ML model. For example, the configuration may indicate resources (e.g., via a Resource ID, carrier ID, BWP ID, resource mapping, frequency band), meta information (e.g., used for indicating a transmit antenna configuration) and digital/analog beamforming. According to one or more examples, the UE performs channel estimation based on the RS, and performs processing of the channel estimation to obtain the data used for training (if needed, such as channel whitening, SVD of the channel estimate to obtain a target precoder V). The UE may upload the collected data, for example, to a training entity through its server via proprietary signaling.

In real-word deployments, the collected data may be generated via channel estimation methods based on an actual channel with noise. Because obtaining the ideal channel estimate (w/o error) is not possible, the training may use the noisy channel estimates (i.e., non-ideal channel). The model trained with such a data set may not be able to achieve de-noising capability, because the input to the ML model and the ground-truth are calculated based on noisy channel estimation. Ground truth generally refers to the reality to be modeled by an ML model, such as target CSI in this example.

Aspects of the present disclosure, however, allow the use of a more “ideal” ground-truth (that is at least less noisy than the ML model input) for ML model training. As a result, the techniques presented herein may help improve ML model training and overall performance.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

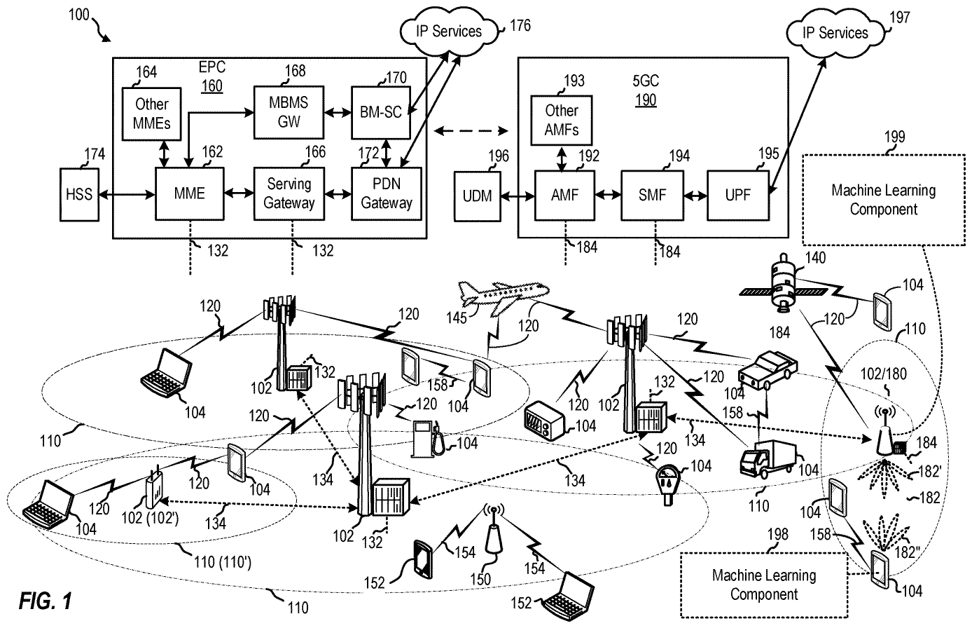

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IOT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

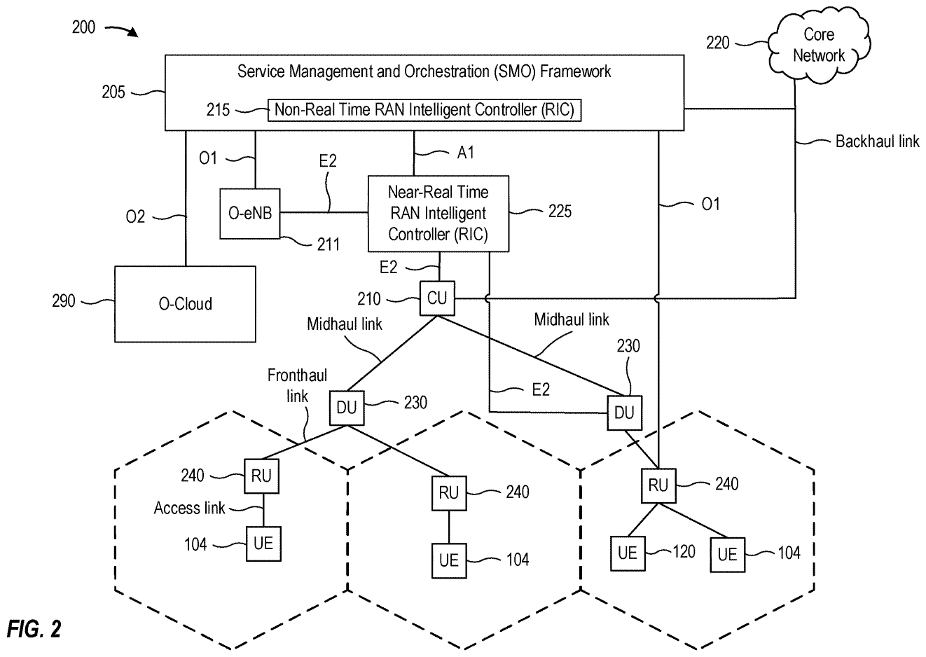

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

Wireless communication network 100 includes a machine learning component 199, which may perform the operations described herein related to machine learning timelines and/or machine learning concurrent processing. Wireless network 100 further includes a machine learning component 198, which may perform the operations described herein related to machine learning timelines and/or machine learning concurrent processing.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

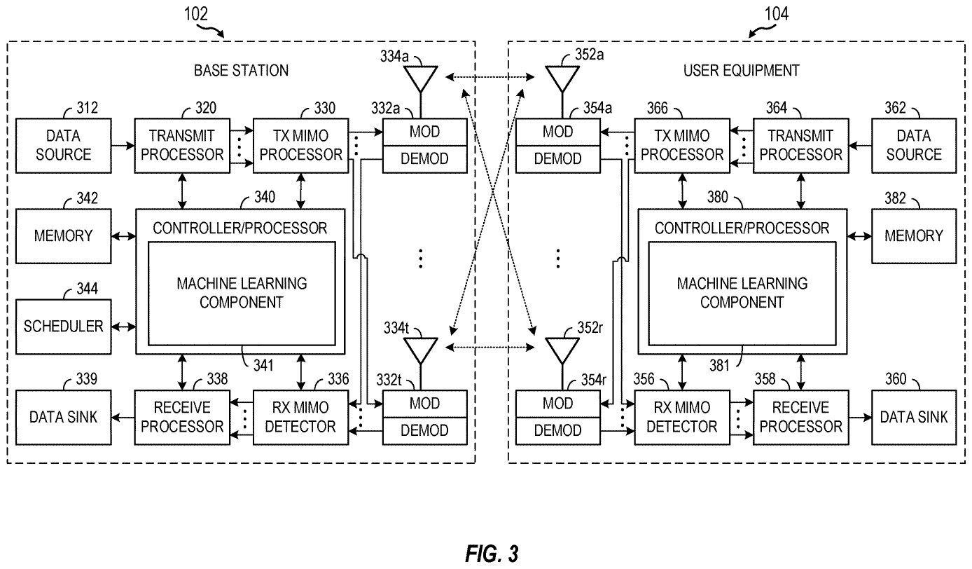

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Base station 102 includes controller/processor 340, which may be configured to implement various functions related to wireless communications. In the depicted example, controller/processor 340 includes machine learning component 241, which may be representative of the machine learning component 199 of FIG. 1. Notably, while depicted as an aspect of controller/processor 340, the machine learning component 341 may be implemented additionally or alternatively in various other aspects of base station 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

User equipment 104 includes controller/processor 380, which may be configured to implement various functions related to wireless communications. In the depicted example, controller/processor 380 includes machine learning component 381, which may be representative of the machine learning component 198 of FIG. 1. Notably, while depicted as an aspect of controller/processor 380, the machine learning component 381 may be implemented additionally or alternatively in various other aspects of user equipment 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

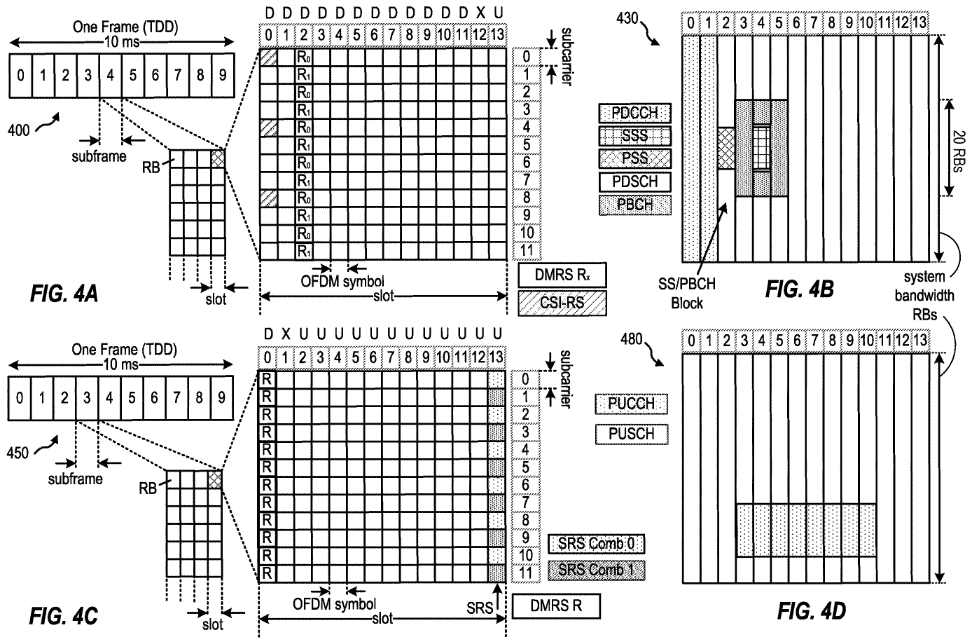

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, an d64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

In 5G NR two initial operating bands have been identified as frequency range designations FR1 (410 MHz-7125 MHz) and FR2 (24,250 MHz-71,000 MHz). In some cases, FR2 may be further defined in terms of sub-ranges, such as a first sub-range FR2-1 including 24,250 MHz-52,600 MHz and a second sub-range FR2-2 including 52,600 MHz-71,000 MHz. It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Communications using mmWave/near mmWave radio frequency band (e.g., 3 GHZ-300 GHz) may have higher path loss and a shorter range compared to lower frequency communications. As described above with respect to FIG. 1, a base station (e.g., 180) configured to communicate using mmWave/near mmWave radio frequency bands may utilize beamforming (e.g., 182) with a UE (e.g., 104) to improve path loss and range.

Further, as described herein, a UE may estimate a channel or generate channel state information in mmWave bands and/or other frequency bands using machine learning model(s).

### Overview of AI/ML Functional Framework for RAN Intelligence

The AI/ML functional framework includes a data collection function 502, a model training function 504, a model inference function 506, and an actor function 508, which interoperate to provide a platform for collaboratively applying AI/ML to various procedures in RAN.

The data collection function 502 generally provides input data to the model training function 504 and the model inference function 506. AI/ML algorithm specific data preparation (e.g., data pre-processing and cleaning, formatting, and transformation) may not be carried out in the data collection function 502.

Examples of input data to the data collection function 502 (or other functions) may include measurements from UEs or different network entities, feedback from the actor function, and output from an AI/ML model. In some cases, analysis of data needed at the model training function 504 and the model inference function 506 may be performed at the data collection function 502. As illustrated, the data collection function 502 may deliver training data to the model training function 504 and inference data to the model inference function 506.

The model training function 504 may perform AI/ML model training, validation, and testing, which may generate model performance metrics as part of the model testing procedure. The model training function 504 may also be responsible for data preparation (e.g., data pre-processing and cleaning, formatting, and transformation) based on the training data delivered by the data collection function 502, if required.

The model training function 504 may provide model deployment/update data to the Model interface function 506. The model deployment/update data may be used to initially deploy a trained, validated, and tested AI/ML model to the model inference function 506 or to deliver an updated model to the model inference function 506.

As illustrated, the model inference function 506 may provide AI/ML model inference output (e.g., predictions or decisions) to the actor function 508 and may also provide model performance feedback to the model training function 504, at times. The model inference function 506 may also be responsible for data preparation (e.g., data pre-processing and cleaning, formatting, and transformation) based on inference data delivered by the data collection function 502, at times.

The inference output of the AI/ML model may be produced by the model inference function 506. Specific details of this output may be specific in terms of use cases. The model performance feedback may be used for monitoring the performance of the AI/ML model, at times. In some cases, the model performance feedback may be delivered to the model training function 504, for example, if certain information derived from the model inference function is suitable for improvement of the AI/ML model trained in the model training function 504.

The model inference function 506 may signal the outputs of the model to nodes that have requested them (e.g., via subscription), or nodes that take actions based on the output from the model inference function. An AI/ML model used in a model inference function 506 may need to be initially trained, validated and tested by a model training function before deployment. The model training function 504 and model inference function 506 may be able to request specific information to be used to train or execute the AI/ML algorithm and to avoid reception of unnecessary information. The nature of such information may depend on the use case and on the AI/ML algorithm.

The actor function 508 may receive the output from the model inference function 506, which may trigger or perform corresponding actions. The actor function 508 may trigger actions directed to other entities or to itself. The feedback generated by the actor function 508 may provide information used to derive training data, inference data or to monitor the performance of the AI/ML Model. As noted above, input data for a data collection function 502 may include this feedback from the actor function 508. The feedback from the actor function 508 or other network entities (via Data Collection function) may also be used at the model inference function 506.

The AI/ML functional framework 500 may be deployed in various RAN intelligence-based use cases. Such use cases may include CSI feedback enhancement, enhanced beam management (BM), positioning and location (Pos-Loc) accuracy enhancement, and various other use cases.

In certain aspects, a UE or a BS may perform ML-based beam prediction using continuous measured or reported L1-RSRP in time domain. In some cases, a pre-trained deep neural network (DNN) model may be used for such ML-based predictive beam management.

Traditionally, beam qualities and failures are identified through measurement reports carried by relevant downlink (DL) and uplink (UL) reference signals (e.g., SSB, CSI-RS, RSRP), which increase beam selection latency and beam management overhead, while at the same beam selection accuracy may be limited due to restrictions on power and overhead that may cause poor system performance.

Instead, the AI/ML based predictive beam management may reduce the amount of reference signal transmissions used to predict non-measured beam qualities and future possibility of beam blockage/failure. In predictive beam management, beam prediction may be a highly non-linear problem, which may be efficiently solved by the pre-trained DNN model that may predict future beam qualities, for example, based on a UE moving speed and trajectory that is difficult to be modeled through statistical processing methods.

### Overview of ML Model Based Techniques

Various techniques may be used to help determine the channel state between wireless communications devices so that those devices can optimize their wireless communications configurations (e.g., choosing the best beam for transmitting and receiving data). For example, a channel state information reference signal (CSI-RS) may be transmitted by one device and measured by another device in order to estimate channel state and to provide channel state information (CSI) feedback that is useful for optimizing wireless communications between the two devices.

However, owing to the growing complexity and capability of wireless communication devices, such as those capable of transmitting and receiving over multiple input and output antenna ports (e.g., implementing multiple-input multiple-output (MIMO) techniques), certain techniques may require significant processing power and time, which reduces the performance of both the devices and the overall wireless communications network. These technical problems are exacerbated by certain use cases and environments for wireless communications, which are often dynamic. In other words, because channel state is frequently changing, channel estimation and feedback procedures are often performed frequently, leading to high power use and significant network overhead (e.g., in terms of time and frequency resources dedicated to channel estimation) for the wireless communication system. One method of mitigating such issues is to implement machine learning models that may more accurately, and more efficiently, perform various functions related to channel state estimation and feedback.

For example, wireless communication systems may multiplex Nₜ ports on Nₜ resource elements of each resource block using, for example, time division multiplexing (TDM), code division multiplexing (CDM), and/or frequency division multiplexing (FDM). Such systems may generally implement a resource block density between 0.5 and 1, such that the resource elements are transmitted in every other or every single resource block. By contrast, a machine learning model deployed by a transmitting device (e.g., a base station) may be trained to perform multiplexing of Nₜ ports on L resource elements of each resource block, where L<Nₜ, which thus reduces the number of resource elements needed for channel estimation-leaving more resource elements available for data transmission. In addition to reducing the number of resource elements needed for channel estimation, which reduces power and enhances resource utilization, such models may operate with reduced resource block density (e.g., below 0.5) and non-uniform resource block patterns may also be implemented, which further improve upon the aforementioned benefits. At a receiving device (e.g., a user equipment) side, a machine learning-based channel estimator may be trained to recover the full channel, e.g., Nₜ ports on all resource blocks while receiving the reduced number of resource, L. In various aspects, CSI-RS multiplexing models at transmitter side and receiver side may be trained jointly or sequentially.

As another example, a CSI reporting configuration may rely on a precoding matrix indicator (PMI) searching algorithm as well as a PMI codebook for determining and reporting the best PMI codewords (e.g., CSI feedback) to a network. However, a machine learning-based model, such as an encoder and decoder, may be trained to generate CSI feedback directly, which obviates the need for the PMI searching algorithm (replaced by the encoder) and the PMI codebook (replaced by the decoder). In aspects described herein, a CSI encoder at the user equipment side may be trained to compress the channel estimate to a few bits that are then reported to a network entity (e.g., a base station), while the CSI decoder at the network entity side is trained to recover the channel or the precoding matrix using the reported bits.

Thus, generally speaking, machine learning models may be trained to perform many functions related to channel estimation and feedback, and such models may generally be more accurate, faster, more power efficient, and more capable of maintaining performance in very dynamic radio environments.

There are various options for what type of information to feedback as channel state feedback (CSF) and the decision of what to feedback may depend on a particular implementation (e.g., whether AI/ML-based or not). The type of feedback may range (in a continuum from relatively sparse information, such as rank indicator (RI), PMI, and channel quality indicator (CQI), to detailed, full channel, information.

For CSI feedback, a CSI report configuration may include a codebook. The codebook is used as a precoding matrix indicator (PMI) dictionary, from which the UE may select and report the best PMI codewords, using a sequence of bits to report the PMI.

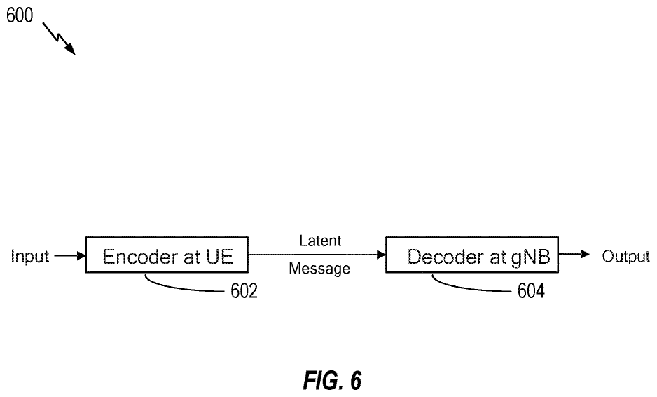

As illustrated in the example block diagram 600 of FIG. 6, in some cases, AI-based CSI feedback may replace the codebook by a CSI encoder 602 (at the UE) and a decoder 604 at the network (e.g., gNB). In some cases, the encoder may not be needed and just the decoder may be used. In general, the encoder is analogous to the PMI searching algorithm in current systems, while the decoder is generally analogous to the PMI codebook, which is used to translate the CSI reporting bits to a PMI code word.

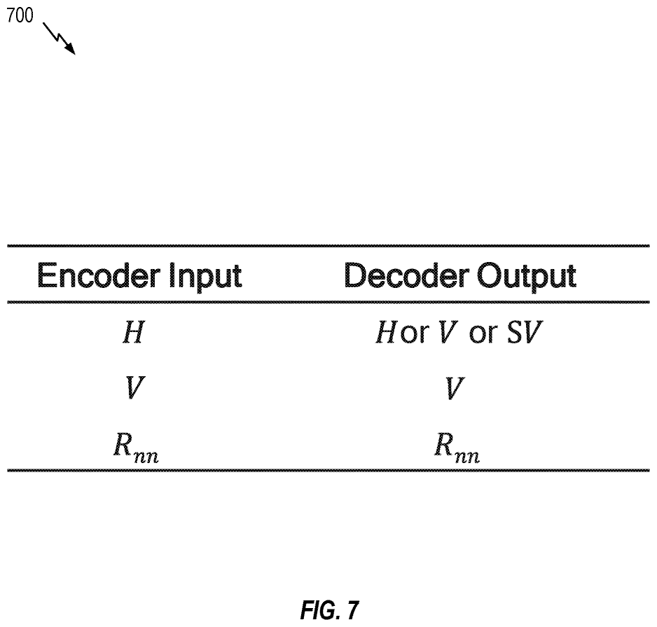

As illustrated in the table 700 of FIG. 7, input to the decoder include a downlink channel matrix (H), downlink precoders (V), and interference covariance matrix (Rnn). Output of the decoder could be downlink channel matrix (H), transmit covariance matrix, downlink precoders (V), interference covariance matrix (Rnn), where H or V could correspond to raw channel or channel pre-whitened by UE based on its demodulation filter.

In certain ML models used for CSI measurement and reporting, a UE and network entity (e.g., gNB) may collaborate by sharing assistance information. For example, in one form of collaboration, inter-node assistance may help improve the respective nodes of an ML based algorithm. This may apply to UEs receiving assistance information from gNBs (e.g., for training, adaptation, etc.), as well as UEs receiving assistance information from gNBs. In some cases, assistance information may be exchanged without exchanging information about the actual ML models. In other cases (e.g., for joint ML operation), a UE and gNB may exchange information regarding ML models or ML model instruction.

ML based CSI schemes involving low-density CSI-RS patterns are examples of scenarios where information may be exchanged between a UE and gNB. For example, due to an association between low-density CSI-RS patterns and a UE channel estimation (CHEST) ML model. In some cases, a CHEST ML model may need to be changed. For example, when the environment changes, the CSI-RS pattern may be changed. In such cases, the UE may need assistance information from the gNB for training, adaptation, and the like.

Reduction along the frequency dimension may be based on the low-density resource block (RB) pattern. For example, K RBs out of N RBs (K<N) may be selected to transmit CSI-RS. In such cases, the pattern could be a uniform RB pattern, a random RB pattern, or a learned RB pattern (e.g., some form of pattern may be used specifically for certain scenarios).

Non-orthogonal cover codes may be used to multiplex N_t CSI-RS ports onto L resource elements (REs) within an RB, where L<N_t. The UE may use an ML model associated with the low-density CSI-RS pattern to recover the channel matrix h.

Reduction along the frequency dimension may be based on the low-density resource block (RB) pattern. For example, K RBs out of N RBs (K<N) may be selected to transmit CSI-RS. In such cases, the pattern could be a uniform RB pattern, a random RB pattern, or a learned RB pattern (e.g., some form of pattern may be used specifically for certain scenarios).

Non-orthogonal cover codes may be used to multiplex N_t CSI-RS ports onto L resource elements (REs) within an RB, where L<N_t. The UE may use an ML model associated with the low-density CSI-RS pattern to recover the channel matrix h.

A UE may receive signaling, from the network entity, indicating at least a first CSI-RS pattern. The first CSI-RS pattern may indicate time and frequency resources (e.g., RBs and/or REs within an RB) used for CSI-RS transmissions. The first CSI-RS pattern may indicate a lower density of CSI-RS resources in a channel frequency range, than a second (e.g., full-density) CSI-RS pattern.

The UE may update an ML model based on the first CSI-RS pattern. For example, as noted above, during training the UE may apply a loss function by comparing output of the ML model, generated based on measurements taken from CSI-RS transmitted according to the first CSI-RS pattern, to a ground-truth estimated channel obtained by using the full-density CSI-RS pattern. The first CSI-RS pattern may also be used when the UE uses the ML model for channel estimation (e.g., after the ML model is well-trained and ready to use).

For example using the updated ML model, the UE may generate CSI for the channel frequency range based on measurements taken by the UE according to the first CSI-RS pattern. For example, the UE may input measurements taken from CSI-RS transmitted according to the first CSI-RS pattern, to the trained ML model to generate a channel estimate. The UE may then transmit a report to the network entity indicating the CSI for the channel frequency range.

Aspects Related to Data Collection with Ideal and Non-Ideal Channel Estimation

As noted above, a UE may be configured with a reference signal (RS) configuration to collect data to use for training an ML model. For example, the configuration may indicate resources (e.g., via a Resource ID, carrier ID, BWP ID, resource mapping, frequency band), meta information (e.g., used for indicating a transmit antenna configuration) and digital/analog beamforming. The UE performs channel estimation based on the RS, and perform processing of the channel estimation to obtain the data used for training (if needed, such as channel whitening, SVD of the channel estimate to obtain a target precoder V). The UE may upload the collected data, for example, to a training entity through its server via proprietary signaling.

There are various types for ML model training. For example, a first type of training, referred to as joint training (or centralized training), may be performed at a single training entity (e.g., a UE/gNB-side server or 3^{rd} party). In this case, a UE may provide input data and the target output data (e.g., the ground-truth) to the training entity where training happens. In some cases, the UE may provide input data and the target output data to its server, and the server forward the input data and the target output data to the training entity via proprietary signaling. After training, the model may be tested, complied (e.g., confirmed to be in compliance with performance objectives), and stored in a model repository, and the UE/gNB download the model from there.

A second type of training may be joint training performed at both UE-side server and gNB-side server. In this case, a single training session may happen across the two-sides. In each iteration, a UE side server may provide activation to the gNB-side server, and gNB-side server may provide a gradient to the UE side server for the UE side server to update their ML models. In this case, the target output data (the ground-truth) is provided to the gNB-side server (e.g., with data flowing from UE->UE server->gNB server), and the input data is provided to the UE server, both of which may be provided via proprietary signaling.

A second type of training may be separate training at UE-side server and gNB-side server. In this case, training happens at the UE-side first and followed by gNB side (or vice-versa). For example, the UE may train its encoder-decoder pair, provide latent information (e.g., encoder output/decoder input) and target decoder output (or just the decoder output) to the gNB side. The gNB side server may train its decoder using this latent information as input and using the target decoder output (or the UE-side decoder output) as the ground-truth. In this approach, target output data and input data may be provided to the UE server, where the UE side training happens, via proprietary signaling. After UE side training is done, the latent message and the target decoder output, or the output of the UE-side decoder, are provided to the gNB side server via proprietary signaling.

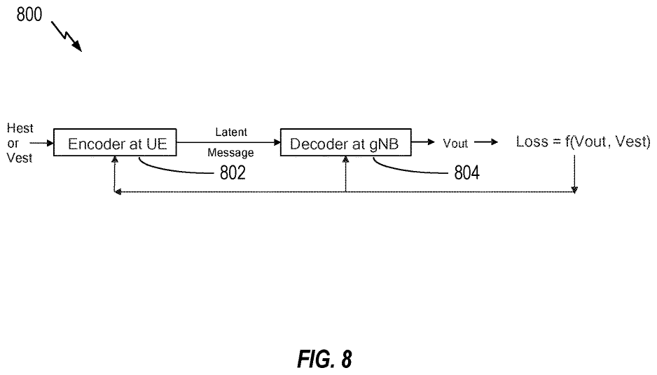

As illustrated in FIG. 8, the collected (training) data may be generated via channel estimation methods. The example shown in FIG. 8 shows an ML-model involving an encoder 802 at the UE and decoder 804 at the network entity (gNB).

Because obtaining the ideal channel estimate (w/o error) is not possible, the training may use noisy channel estimates (i.e., non-ideal channel). The model trained with such a data set, comparing a precoder output from decoder 804 (Vout) to the model data input to encoder 802 (Vest), may not be able to achieve de-noising capability, because the input to the ML model and the ground-truth are calculated based on noisy channel estimation.

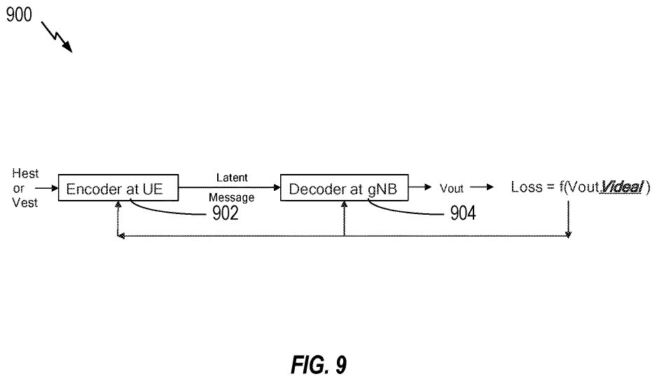

As illustrated in FIG. 9, which shows an example ML-model involving an encoder 902 at the UE and decoder 904 at the network entity (gNB), aspects of the present disclosure, however, allow the use of a more “ideal” target ground-truth (that is at least less noisy than the ML model input) for ML model training. In this case, the model may be trained with such a data set, comparing the precoder output from decoder 904 (Vout) to more ideal target model output data, Vtarget. As a result, the techniques presented herein may help improve ML model training and overall performance.

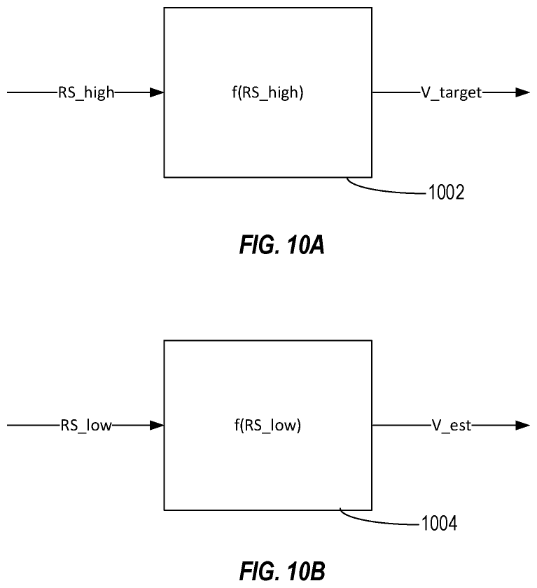

In some cases, the target model output may be obtained from the measurement of high-density reference signal (RS_high). In other words, as illustrated in module 1002 of FIG. 10A, Vtarget may be determined as a function of RS_high (e.g., Vtarget=f(RS_high)). On the other hand, as illustrated in module 1004 of FIG. 10B, the normal training data set may be obtained from the measurement of low-density reference signal, RS_low (e.g., Vest=f(RS_low)).

In some cases, a network entity (e.g., gNB) may transmit a configuration of the high density RS pattern and/or low density pattern to the UE. In some cases, a training entity may adopt the nominal data as input, and target output data as their respective ground-truth. As used herein, nominal data generally refers to data input to an ML model to generate the ML data output. The nominal data and target model output data may be provided for training an ML model. For training purposes, the actual ML data output may be compared to the expected target model output data.

According to certain aspects, a high-density RS (e.g., CSI-RS) pattern (used to determine Vtarget) may have a CSI-RS density greater than one (density>1). CSI-RS density generally refers to the number of CSI-RS observations (receptions) per resource block (RB), e.g., a number of REs allocated for CSI-RS per CSI-RS port per RB. A lower density RS (CSI-RS), with less CSI-RS observations per RB than the high-density RS) may be obtained by nulling the observations (ignoring receptions) on corresponding tones. In other cases, rather than nulling, multiple CSI-RS resources may be configured, and a UE may obtain multiple CSI-RS patterns from the multiple resources.

In some cases, a UE may receive configuration of a high density RS (e.g., with density=3) and determine a nulling pattern or nulling tone index for the low-density RS (e.g., with density=1). In some cases, the nulling tone index (or pattern) can be cell-specific (e.g., configured per cell, or determined based on a cell ID). In other words, the lower density RS may be obtained by applying the nulling tone index or pattern to obtain a subset of the high density RS (resources) to use as the low density RS.

In some cases, the higher density RS pattern may be an aggregate of multiple low-density RS resources. In other words, the higher density RS may be obtained by aggregating a plurality of lower density RS (resources). In such cases, the UE may receive a configuration of N lower-density RS resources for data collection. The N resources may be bundled and triggered together, which generally means that the target output is resulted from measurement of N bundled resources, while a nominal dataset may result from measurement of single resource.

The N resources can be multiplexed in frequency domain or time domain. In some cases, each resource may have a particular RE location, or symbol/slot location. In some cases, the N resources may have the same quasi co-located (QCL) reference signal and type (e.g., type A, B, C, and/or D), including Doppler shift, average gain, delay spread, max delay, Rx spatial information, or they may be QCL′d (meaning the share one or more common QCL parameters) to each other.

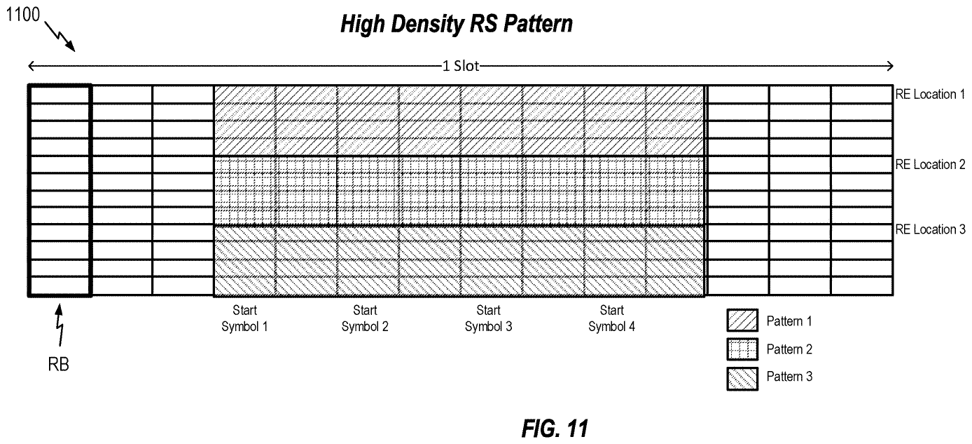

As illustrated in FIG. 11, in some cases, to facilitate the high density RS (>1), and to facilitate multiplexing of three low-density (e.g., nominal CSI-RS density=1) CSI-RS resource in one slot 1100, a new CSI-RS pattern may be needed. For example, a total of 96REs may be needed for 32-port CSI-RS transmission.

As illustrates in FIG. 11, a new 4×8 CSI-RS pattern may be defined that has a total of 4 starting symbol location in time domain. In the example, each starting symbol generally implies two consecutive symbols. The 4 starting symbol locations can be uniformly distributed (as shown) or may non-uniformly distributed.

In some cases, for 32-port CSI-RS transmission, 8 symbols may be used (e.g., spanning the 4 illustrated starting symbol locations. For other cases, for 24-port CSI-RS transmission, 6 symbols may be used (3 starting symbol location). For other cases, 16-port CSI-RS transmission, 4 symbols may be used (2 starting symbol locations). For 32-portCSI-RS transmission, the first 16 ports may be mapped to first four symbols, while the rest of the 16 ports may be mapped to last 4 symbols.

In the example configuration shown in FIG. 11, there are 3 possible RE location (0, 4, 8). With a CSI-RS density of three, all three possible RE locations may be occupied. A density of one, on the other hand, would mean only one of them is occupied (e.g., 3 resource may occupy 3 RE locations). According to one example, 3 REs per port per RB may be occupied.

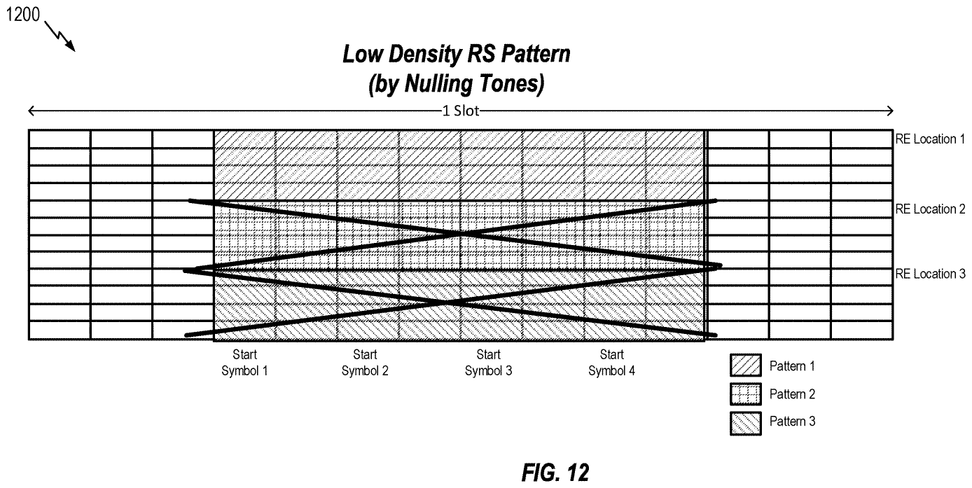

Referring to FIG. 12, considering a 32-port CSI-RS, a first copy of these 32 ports may occupy 4×8 REs (labeled Pattern 1) with subcarrier 0-3 and symbols 2-9. A second copy may occupy 4×8 REs (labeled Pattern 2) with subcarrier 4-7 and symbol 2-9. A third copy may occupy 4×8 REs (labeled Pattern 3) with subcarrier 8-11 and symbol 2-9. As illustrated in FIG. 12, for low density RS to collect nominal data for ML training, the UE may ignore the 2^{nd} copy and 3^{rd} copy on subcarrier 4-11. In some cases, a time domain (TD) orthogonal cover code (OCC) 8 may be used or frequency domain (e.g., FD2-TD8 or TD-OCC8) code division multiplexed (CDM) pattern may be defined.

In some cases, the same (e.g., 32) ports are transmitted in different (high and low density) patterns (each copy of the CSI-RS observation/reception of a single resource, or each of the multiple CSI-RS resources to be aggregated together). In such cases, aggregating them may result in a better channel estimate by having higher processing gain than the channel estimate resulted by measuring one of the low-density resource or nulling CSI-RS observations/receptions of a high density resource. In some other cases, each a CSI-RS resource is transmitting with different 32 ports, then the UE may use the single resource to perform a port-prediction in spatial domain (output is 64 ports if there are two resources, or output is 96 ports if there are three resources). In this case, the UE may use the aggregated resource to generate the target output of total 64 (or 96) ports. The resulted channel estimate using aggregate resources may have a better channel estimation quality than the port-prediction/port-extrapolation using one of the resource.

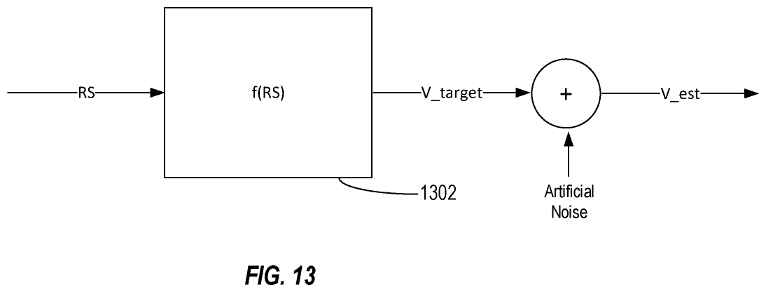

In some cases, as illustrated in FIG. 13, a UE may collect target model output data for a machine learning (ML) model, based on channel measurements taken according to the CSI-RS pattern and generate nominal data for training the ML model by adding artificial noise to the target model output data.

In other words, target model output may be generated using measurement of reference signals (RS) used/configured for data collection and a UE may obtain (Vtarget=f(RS)), As illustrated in FIG. 13, however, the dataset used in training may be generated by adding artificial noise to the target model output (Vest-f(RS)+noise).

UE will include, in the data collection, the statistics of the artificial noise, e.g., variance, or the ratio between the channel estimate power and noise variance (i.e., SNR)

The statistics can be different per each data sample, there can be multiple noisy version added to the same sample:

$$Vest 1 = f ( R S ) + noise 1 , Vest 2 = f ( RS\_high ) = f ( R S ) + n o ise 2 , etc .$$

where two noises can have different statistics.

There are various options for delivering training data (regardless of which option above is used). For example, for joint training at a single-entity, a UE may upload the (Vest, Vtarget) or (Hest, Vtarget) to the training entity or model server (e.g., where the model server may forward the data to training entity). In such cases, the training entity takes Vest or Hest as input, and Vtarget may be the ground-truth as target to approximate

For joint training across UE and gNB, the UE may upload the Vtarget to its model server and the model server exchange with the gNB side server via proprietary signaling, or the UE could upload Vtarget to the gNB side server directly. In this cases, the UE side server may take Vest as input, the gNB side server use Vtarget as the ground-truth as the target to approximate

In some cases, in separate training using a UE-driven approach, the UE may upload (Vest, Vtarget) or (Hest, Vtarget). to its model server, the server train the UE-side encoder and decoder pair using Vest/Hest as input and Vtarget as a target. In such cases, the encoder output z and Vtarget (or the output of the UE-side decoder) may be shared with a gNB server via proprietary signaling. The gNB may train its decoder using z as input and Vtarget (or the output of the UE-side decoder) as a target.

In some cases, a gNB-driven approach may be used. In this case, the UE may upload an indication of (Vest, Vtarget) or (Hest, Vtarget) to its model server, and the server may share (e.g., Vest, Vtarget) or (e.g., Hest, Vtarget) to the gNB server. Then, the gNB server may use Vest/Hest as input and Vtarget as target to train its encoder and decoder pair. While examples herein refer to a ML models based on encoder/decoder pairs, the techniques presented herein may be applied to ML models that do not use encoder/decoder pairs. The gNB server may deliver the encoder output z to the UE, and the UE may use Vest/Hest as the input to train its encoder and use z as the target output of the encoder. In some cases, the signal to noise ratio (SNR) or reference signal to received power (RSRP) of the received CSI-RS can be uploaded with each sample, e.g., when providing ML model training data).

### Example Operations of User Equipment

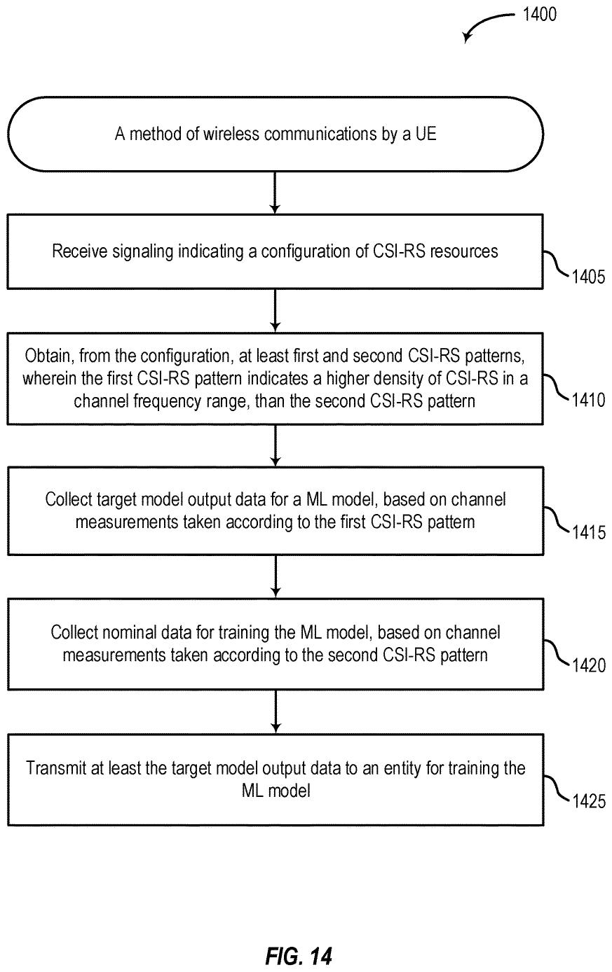

FIG. 14 shows an example of a method 1400 of wireless communications by a UE, such as a UE 104 of FIGS. 1 and 3.

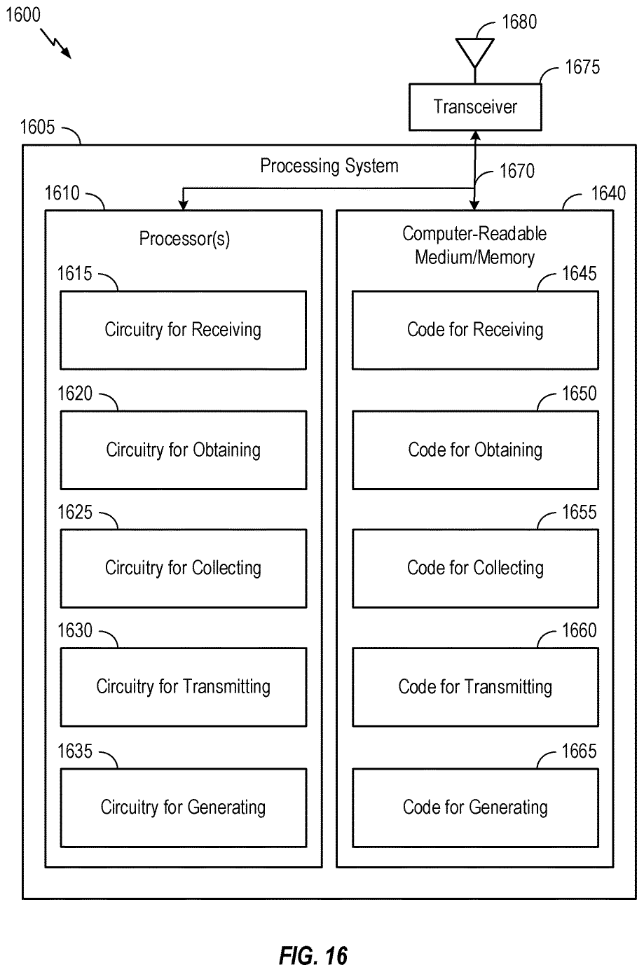

Method 1400 begins at step 1405 with receiving signaling indicating a configuration of CSI-RS resources. In some cases, the operations of this step refer to, or may be performed by, circuitry for receiving and/or code for receiving as described with reference to FIG. 16.

Method 1400 then proceeds to step 1410 with obtaining, from the configuration, at least first and second CSI-RS patterns, wherein the first CSI-RS pattern indicates a higher density of CSI-RS in a channel frequency range, than the second CSI-RS pattern. In some cases, the operations of this step refer to, or may be performed by, circuitry for obtaining and/or code for obtaining as described with reference to FIG. 16.

Method 1400 then proceeds to step 1415 with collecting target model output data for a ML model, based on channel measurements taken according to the first CSI-RS pattern. In some cases, the operations of this step refer to, or may be performed by, circuitry for collecting and/or code for collecting as described with reference to FIG. 16.

Method 1400 then proceeds to step 1420 with collecting nominal data for training the ML model, based on channel measurements taken according to the second CSI-RS pattern. In some cases, the operations of this step refer to, or may be performed by, circuitry for collecting and/or code for collecting as described with reference to FIG. 16.

Method 1400 then proceeds to step 1425 with transmitting at least the target model output data to an entity for training the ML model. In some cases, the operations of this step refer to, or may be performed by, circuitry for transmitting and/or code for transmitting as described with reference to FIG. 16.

In some aspects, the second CSI-RS pattern comprises a subset of CSI-RS of the first CSI-RS pattern.

In some aspects, obtaining, from the configuration, at least first and second CSI-RS patterns, comprises: obtaining the first CSI-RS pattern from the configuration; and obtaining the second CSI-RS pattern from the first CSI-RS pattern and a nulling tone pattern.

In some aspects, the nulling tone pattern is cell-specific.

In some aspects, the first CSI-RS pattern has a CSI-RS density greater than one, wherein CSI-RS pattern density indicates a number of CSI-RS per RB.

In some aspects, the first CSI-RS pattern is configured with: up to four start symbol locations in a slot; and a total number of up to eight symbols in the slot.

In some aspects, the first CSI-RS pattern comprises a superset of CSI-RS resources of the second CSI-RS pattern.

In some aspects, obtaining, from the configuration, at least first and second CSI-RS patterns, comprises: obtaining the second CSI-RS pattern from a plurality of CSI-RS patterns indicated by the configuration for data collection; and obtaining the first CSI-RS pattern by aggregating the plurality CSI-RS patterns.

In some aspects, the method 1400 further includes receiving a resource-bundling configuration, wherein the aggregating is based on the resource-bundling configuration. In some cases, the operations of this step refer to, or may be performed by, circuitry for receiving and/or code for receiving as described with reference to FIG. 16.

In some aspects, the plurality of CSI-RS patterns are multiplexed in at least one of frequency or time.

In some aspects, the plurality of CSI-RS patterns have a same QCL reference signal and type or are QCL′d to each other.

In some aspects, common CSI-RS ports are transmitted in both the first CSI-RS pattern and the second CSI-RS pattern.

In some aspects, a first set of CSI-RS ports are transmitted in the first CSI-RS pattern and a second set of CSI-RS ports are transmitted in the second CSI-RS pattern.

In some aspects, the nominal data comprises at least one of downlink precoders (Vest) or downlink channel matrix (Hest) estimated based on channel measurements taken according to the second CSI-RS pattern; and the target model output data comprises target downlink precoders (Vtarget) estimated based on channel measurements taken according to the first CSI-RS pattern.

In some aspects, the entity comprises a model server or training entity; and transmitting at least the target model output data to an entity for training the ML model comprises transmitting Vtarget and at least one of Vest or Hest.

In some aspects, the method 1400 further includes transmitting at least one of SNR or RSRP corresponding to CSI-RS received according to at least one of the first CSI-RS pattern or second CSI-RS pattern. In some cases, the operations of this step refer to, or may be performed by, circuitry for transmitting and/or code for transmitting as described with reference to FIG. 16.

In some aspects, the nominal data is used as input to the ML model; and the target model output data is sample-wise labelled as ground-truth for the ML model.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

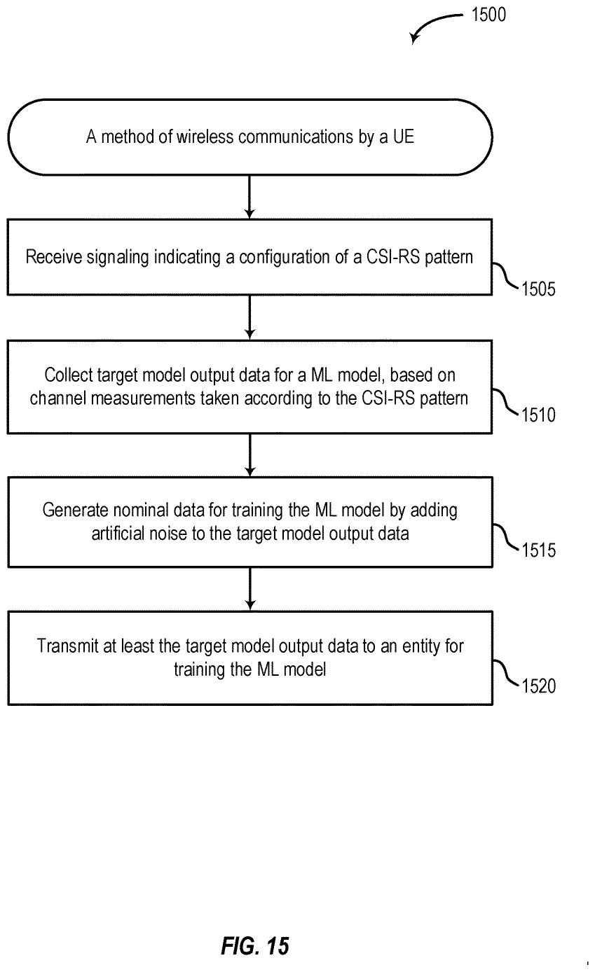

FIG. 15 shows an example of a method 1500 of wireless communications by a UE, such as a UE 104 of FIGS. 1 and 3.

Method 1500 begins at step 1505 with receiving signaling indicating a configuration of a CSI-RS pattern. In some cases, the operations of this step refer to, or may be performed by, circuitry for receiving and/or code for receiving as described with reference to FIG. 16.

Method 1500 then proceeds to step 1510 with collecting target model output data for a ML model, based on channel measurements taken according to the CSI-RS pattern. In some cases, the operations of this step refer to, or may be performed by, circuitry for collecting and/or code for collecting as described with reference to FIG. 16.

Method 1500 then proceeds to step 1515 with generating nominal data for training the ML model by adding artificial noise to the target model output data. In some cases, the operations of this step refer to, or may be performed by, circuitry for generating and/or code for generating as described with reference to FIG. 16.

Method 1500 then proceeds to step 1520 with transmitting at least the target model output data to an entity for training the ML model. In some cases, the operations of this step refer to, or may be performed by, circuitry for transmitting and/or code for transmitting as described with reference to FIG. 16.

In some aspects, the method 1500 further includes transmitting an indication of statistics of the artificial noise. In some cases, the operations of this step refer to, or may be performed by, circuitry for transmitting and/or code for transmitting as described with reference to FIG. 16.

In some aspects, the statistics comprise at least one of a variance or a ratio between a channel estimate power and a noise variance.

In some aspects, the statistics are different for different data samples of the nominal data.

In some aspects, generating the nominal data comprises generating multiple sets of nominal data from common target output data, wherein each set is generated with particular noise statistics.

In some aspects, the nominal data comprises at least one of downlink precoders (Vest) or downlink channel matrix (Hest) estimated based on channel measurements taken according to the CSI-RS pattern; and the target model output data comprises target downlink precoders (Vtarget) estimated based on channel measurements taken according to the CSI-RS pattern.

In some aspects, the entity comprises a model server or training entity; and transmitting at least the target model output data to an entity for training the ML model comprises transmitting Vtarget and at least one of Vest or Hest.

In some aspects, the method 1500 further includes transmitting at least one of SNR or RSRP corresponding to CSI-RS received according to the CSI-RS pattern. In some cases, the operations of this step refer to, or may be performed by, circuitry for transmitting and/or code for transmitting as described with reference to FIG. 16.

In some aspects, the nominal data is used as input to the ML model; and the target model output data is sample-wise labelled as ground-truth for the ML model.

In one aspect, method 1500, or any aspect related to it, may be performed by an apparatus, such as communications device 1600 of FIG. 16, which includes various components operable, configured, or adapted to perform the method 1500. Communications device 1600 is described below in further detail.

Note that FIG. 15 is just one example of a method, and other methods including fewer, additional, or alternative steps are possible consistent with this disclosure.

### Example Communications Device

FIG. 16 depicts aspects of an example communications device 1600. In some aspects, communications device 1600 is a user equipment, such as UE 104 described above with respect to FIGS. 1 and 3.

The communications device 1600 includes a processing system 1605 coupled to the transceiver 1675 (e.g., a transmitter and/or a receiver). The transceiver 1675 is configured to transmit and receive signals for the communications device 1600 via the antenna 1680, such as the various signals as described herein. The processing system 1605 may be configured to perform processing functions for the communications device 1600, including processing signals received and/or to be transmitted by the communications device 1600.

The processing system 1605 includes one or more processors 1610. In various aspects, the one or more processors 1610 may be representative of one or more of receive processor 358, transmit processor 364, TX MIMO processor 366, and/or controller/processor 380, as described with respect to FIG. 3. The one or more processors 1610 are coupled to a computer-readable medium/memory 1640 via a bus 1670. In certain aspects, the computer-readable medium/memory 1640 is configured to store instructions (e.g., computer-executable code) that when executed by the one or more processors 1610, cause the one or more processors 1610 to perform the method 1400 described with respect to FIG. 14, or any aspect related to it, and/or the method 1500 described with respect to FIG. 15, or any aspect related to it. Note that reference to a processor performing a function of communications device 1600 may include one or more processors 1610 performing that function of communications device 1600.

In the depicted example, computer-readable medium/memory 1640 stores code (e.g., executable instructions), such as code for receiving 1645, code for obtaining 1650, code for collecting 1655, code for transmitting 1660, and code for generating 1665. Processing of the code for receiving 1645, code for obtaining 1650, code for collecting 1655, code for transmitting 1660, and code for generating 1665 may cause the communications device 1600 to perform the method 1400 described with respect to FIG. 14, or any aspect related to it, and/or the method 1500 described with respect to FIG. 15, or any aspect related to it.

The one or more processors 1610 include circuitry configured to implement (e.g., execute) the code stored in the computer-readable medium/memory 1640, including circuitry such as circuitry for receiving 1615, circuitry for obtaining 1620, circuitry for collecting 1625, circuitry for transmitting 1630, and circuitry for generating 1635. Processing with circuitry for receiving 1615, circuitry for obtaining 1620, circuitry for collecting 1625, circuitry for transmitting 1630, and circuitry for generating 1635 may cause the communications device 1600 to perform the method 1400 described with respect to FIG. 14, or any aspect related to it, and/or the method 1500 described with respect to FIG. 15, or any aspect related to it.

Various components of the communications device 1600 may provide means for performing the method 1400 described with respect to FIG. 14, or any aspect related to it, and/or the method 1500 described with respect to FIG. 15, or any aspect related to it. For example, means for transmitting, sending or outputting for transmission may include transceivers 354 and/or antenna(s) 352 of the UE 104 illustrated in FIG. 3 and/or the transceiver 1675 and the antenna 1680 of the communications device 1600 in FIG. 16. Means for receiving or obtaining may include transceivers 354 and/or antenna(s) 352 of the UE 104 illustrated in FIG. 3 and/or the transceiver 1675 and the antenna 1680 of the communications device 1600 in FIG. 16.

### EXAMPLE CLAUSES

Implementation examples are described in the following numbered clauses:
Clause 1: A method of wireless communications by a UE, comprising: receiving signaling indicating a configuration of CSI-RS resources; obtaining, from the configuration, at least first and second CSI-RS patterns, wherein the first CSI-RS pattern indicates a higher density of CSI-RS in a channel frequency range, than the second CSI-RS pattern; collecting target model output data for a ML model, based on channel measurements taken according to the first CSI-RS pattern; collecting nominal data for training the ML model, based on channel measurements taken according to the second CSI-RS pattern; and transmitting at least the target model output data to an entity for training the ML model.
Clause 2: The method of Clause 1, wherein the second CSI-RS pattern comprises a subset of CSI-RS of the first CSI-RS pattern.
Clause 3: The method of Clause 2, wherein obtaining, from the configuration, at least first and second CSI-RS patterns, comprises: obtaining the first CSI-RS pattern from the configuration; and obtaining the second CSI-RS pattern from the first CSI-RS pattern and a nulling tone pattern.
Clause 4: The method of Clause 3, wherein the nulling tone pattern is cell-specific.
Clause 5: The method of Clause 3, wherein the first CSI-RS pattern has a CSI-RS density greater than one, wherein CSI-RS pattern density indicates a number of CSI-RS per RB.
Clause 6: The method of Clause 3, wherein the first CSI-RS pattern is configured with: up to four start symbol locations in a slot; and a total number of up to eight symbols in the slot.
Clause 7: The method of any one of Clauses 1-6, wherein the first CSI-RS pattern comprises a superset of CSI-RS resources of the second CSI-RS pattern.
Clause 8: The method of Clause 7, wherein obtaining, from the configuration, at least first and second CSI-RS patterns, comprises: obtaining the second CSI-RS pattern from a plurality of CSI-RS patterns indicated by the configuration for data collection; and obtaining the first CSI-RS pattern by aggregating the plurality CSI-RS patterns.
Clause 9: The method of Clause 8, further comprising: receiving a resource-bundling configuration, wherein the aggregating is based on the resource-bundling configuration.
Clause 10: The method of Clause 8, wherein the plurality of CSI-RS patterns are multiplexed in at least one of frequency or time.
Clause 11: The method of Clause 8, wherein the plurality of CSI-RS patterns have a same QCL reference signal and type or are QCL′d to each other.
Clause 12: The method of Clause 8, wherein common CSI-RS ports are transmitted in both the first CSI-RS pattern and the second CSI-RS pattern.
Clause 13: The method of Clause 8, wherein a first set of CSI-RS ports are transmitted in the first CSI-RS pattern and a second set of CSI-RS ports are transmitted in the second CSI-RS pattern.
Clause 14: The method of any one of Clauses 1-13, wherein: the nominal data comprises at least one of downlink precoders (Vest) or downlink channel matrix (Hest) estimated based on channel measurements taken according to the second CSI-RS pattern; and the target model output data comprises target downlink precoders (Vtarget) estimated based on channel measurements taken according to the first CSI-RS pattern.
Clause 15: The method of Clause 14, wherein: the entity comprises a model server or training entity; and transmitting at least the target model output data to an entity for training the ML model comprises transmitting Vtarget and at least one of Vest or Hest.
Clause 16: The method of Clause 15, further comprising: transmitting at least one of SNR or RSRP corresponding to CSI-RS received according to at least one of the first CSI-RS pattern or second CSI-RS pattern.
Clause 17: The method of any one of Clauses 1-16, wherein: the nominal data is used as input to the ML model; and the target model output data is sample-wise labelled as ground-truth for the ML model.
Clause 18: A method of wireless communications by a UE, comprising: receiving signaling indicating a configuration of a CSI-RS pattern; collecting target model output data for a ML model, based on channel measurements taken according to the CSI-RS pattern; generating nominal data for training the ML model by adding artificial noise to the target model output data; and transmitting at least the target model output data to an entity for training the ML model.
Clause 19: The method of Clause 18, further comprising: transmitting an indication of statistics of the artificial noise.
Clause 20: The method of Clause 19, wherein the statistics comprise at least one of a variance or a ratio between a channel estimate power and a noise variance.
Clause 21: The method of Clause 19, wherein the statistics are different for different data samples of the nominal data.
Clause 22: The method of any one of Clauses 18-21, wherein generating the nominal data comprises generating multiple sets of nominal data from common target output data, wherein each set is generated with particular noise statistics.
Clause 23: The method of any one of Clauses 18-22, wherein: the nominal data comprises at least one of downlink precoders (Vest) or downlink channel matrix (Hest) estimated based on channel measurements taken according to the CSI-RS pattern; and the target model output data comprises target downlink precoders (Vtarget) estimated based on channel measurements taken according to the CSI-RS pattern.
Clause 24: The method of Clause 23, wherein: the entity comprises a model server or training entity; and transmitting at least the target model output data to an entity for training the ML model comprises transmitting Vtarget and at least one of Vest or Hest.
Clause 25: The method of Clause 24, further comprising: transmitting at least one of SNR or RSRP corresponding to CSI-RS received according to the CSI-RS pattern.
Clause 26: The method of any one of Clauses 18-25, wherein: the nominal data is used as input to the ML model; and the target model output data is sample-wise labelled as ground-truth for the ML model.
Clause 27: An apparatus, comprising: a memory comprising executable instructions; and a processor configured to execute the executable instructions and cause the apparatus to perform a method in accordance with any one of Clauses 1-26.
Clause 28: An apparatus, comprising means for performing a method in accordance with any one of Clauses 1-26.
Clause 29: A non-transitory computer-readable medium comprising executable instructions that, when executed by a processor of an apparatus, cause the apparatus to perform a method in accordance with any one of Clauses 1-26.
Clause 30: A computer program product embodied on a computer-readable storage medium comprising code for performing a method in accordance with any one of Clauses 1-26.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication, comprising:
a memory; and
a processor coupled to the memory, the processor being configured to:
receive signaling indicating a configuration of channel state information (CSI) reference signal (CSI-RS) resources;
obtain, from the configuration, at least first and second CSI-RS patterns, wherein the first CSI-RS pattern indicates a higher density of CSI-RS in a channel frequency range, than the second CSI-RS pattern;
collect target model output data for a machine learning (ML) model, based on channel measurements taken according to the first CSI-RS pattern;
collect nominal data for training the ML model, based on channel measurements taken according to the second CSI-RS pattern; and
transmit at least the target model output data to an entity for training the ML model.

2. The apparatus of claim 1, wherein the second CSI-RS pattern comprises a subset of CSI-RS of the first CSI-RS pattern.

3. The apparatus of claim 2, wherein to obtain, from the configuration, at least first and second CSI-RS patterns, the processor is configured to:
obtain the first CSI-RS pattern from the configuration; and
obtain the second CSI-RS pattern from the first CSI-RS pattern and a nulling tone pattern.

4. The apparatus of claim 3, wherein the nulling tone pattern is cell-specific.

5. The apparatus of claim 3, wherein the first CSI-RS pattern has a CSI-RS density greater than one, wherein CSI-RS pattern density indicates a number of CSI-RS per resource block (RB).

6. The apparatus of claim 3, wherein the first CSI-RS pattern is configured with:
up to four start symbol locations in a slot; and
a total number of up to eight symbols in the slot.

7. The apparatus of claim 1, wherein the first CSI-RS pattern comprises a superset of CSI-RS resources of the second CSI-RS pattern.

8. The apparatus of claim 7, wherein to obtain, from the configuration, at least first and second CSI-RS patterns, the processor is configured to:
obtain the second CSI-RS pattern from a plurality of CSI-RS patterns indicated by the configuration for data collection; and
obtain the first CSI-RS pattern by aggregating the plurality of CSI-RS patterns.

9. The apparatus of claim 8, the processor is further configured to:
receive a resource-bundling configuration, wherein the aggregating is based on the resource-bundling configuration.

10. The apparatus of claim 8, wherein the plurality of CSI-RS patterns are multiplexed in at least one of frequency or time.

11. The apparatus of claim 8, wherein the plurality of CSI-RS patterns have a same quasi co-located (QCL) reference signal and type or are share one or more common QCL parameters to each other.

12. The apparatus of claim 8, wherein common CSI-RS ports are transmitted in both the first CSI-RS pattern and the second CSI-RS pattern.

13. The apparatus of claim 8, wherein a first set of CSI-RS ports are transmitted in the first CSI-RS pattern and a second set of CSI-RS ports are transmitted in the second CSI-RS pattern.

14. The apparatus of claim 1, wherein:
the nominal data comprises at least one of downlink precoders (Vest) or downlink channel matrix (Hest) estimated based on channel measurements taken according to the second CSI-RS pattern; and
the target model output data comprises target downlink precoders (Vtarget) estimated based on channel measurements taken according to the first CSI-RS pattern.

15. The apparatus of claim 14, wherein:
the entity comprises a model server or training entity; and
to transmit, the processor is configured to transmit at least the target model output data to an entity for training the ML model comprises transmitting Vtarget and at least one of Vest or Hest.

16. The apparatus of claim 15, the processor is further configured to transmit at least one of signal to noise ratio (SNR) or reference signal received power (RSRP) corresponding to CSI-RS received according to at least one of the first CSI-RS pattern or second CSI-RS pattern.

17. The apparatus of claim 1, wherein:
the nominal data is used as input to the ML model; and
the target model output data is sample-wise labelled as ground-truth for the ML model.

18. An apparatus for wireless communication, comprising:
a memory; and
a processor coupled to the memory, the processor being configured to:
receive signaling indicating a configuration of a channel state information (CSI) reference signal (CSI-RS) pattern;
collect target model output data for a machine learning (ML) model, based on channel measurements taken according to the CSI-RS pattern;
generate nominal data for training the ML model by adding artificial noise to the target model output data; and
transmit at least the target model output data to an entity for training the ML model.

19. The apparatus of claim 18, the processor is further configured to transmit an indication of statistics of the artificial noise.

20. The apparatus of claim 19, wherein the statistics comprise at least one of a variance or a ratio between a channel estimate power and a noise variance.

21. The apparatus of claim 19, wherein the statistics are different for different data samples of the nominal data.

22. The apparatus of claim 18, wherein to generate the nominal data the processor is configured to generate multiple sets of nominal data from common target output data, wherein each set is generated with particular noise statistics.

23. The apparatus of claim 18, wherein:
the nominal data comprises at least one of downlink precoders (Vest) or downlink channel matrix (Hest) estimated based on channel measurements taken according to the CSI-RS pattern; and
the target model output data comprises target downlink precoders (Vtarget) estimated based on channel measurements taken according to the CSI-RS pattern.

24. The apparatus of claim 23, wherein:
the entity comprises a model server or training entity; and
to transmit at least the target model output data to an entity for training the ML model, the processor is configured to transmit Vtarget and at least one of Vest or Hest.

25. The apparatus of claim 24, the processor is further configured to transmit at least one of signal to noise ratio (SNR) or reference signal received power (RSRP) corresponding to CSI-RS received according to the CSI-RS pattern.

26. The apparatus of claim 18, wherein:
the nominal data is used as input to the ML model; and
the target model output data is sample-wise labelled as ground-truth for the ML model.

27. A method of wireless communications by a user equipment (UE), comprising:
receiving signaling indicating a configuration of channel state information (CSI) reference signal (CSI-RS) resources;
obtaining, from the configuration, at least first and second CSI-RS patterns, wherein the first CSI-RS pattern indicates a higher density of CSI-RS in a channel frequency range, than the second CSI-RS pattern;
collecting target model output data for a machine learning (ML) model, based on channel measurements taken according to the first CSI-RS pattern;
collecting nominal data for training the ML model, based on channel measurements taken according to the second CSI-RS pattern; and
transmitting at least the target model output data to an entity for training the ML model.

28. A method of wireless communications by a user equipment (UE), comprising:
receiving signaling indicating a configuration of a channel state information (CSI) reference signal (CSI-RS) pattern;
collecting target model output data for a machine learning (ML) model, based on channel measurements taken according to the CSI-RS pattern;
generating nominal data for training the ML model by adding artificial noise to the target model output data; and
transmitting at least the target model output data to an entity for training the ML model.
